(19) United States
(12) Patent Application Publication
(10) Pub. No.: US 2025/0376153 A1
(43) Pub. Date: Dec. 11, 2025

(54) CHASSIS-INTEGRATED CONTROLLER AND VEHICLE CONTROL SYSTEM INCLUDING SAME

(71) Applicant: HL MANDO CORPORATION, Pyeongtaek-si (KR)

(72) Inventor: Young Eun CHO, Pyeongtaek-si (KR)

(73) Assignee: HL MANDO CORPORATION, Pyeongtaek-si (KR)

(21) Appl. No.: 19/050,418

(22) Filed: Feb. 11, 2025

(30) Foreign Application Priority Data
Jun. 10, 2024 (KR) 10-2024-0075282

(51) Int. Cl. B60W 30/045; B60W 10/18; B60W 10/20; B60W 10/22; B60W 50/02

(52) U.S. Cl. CPC B60W 30/045; B60W 10/18; B60W 10/20; B60W 10/22; B60W 50/0205; B60W 2552/40; B60W 2720/14

(57) ABSTRACT

Provided is a chassis-integrated controller. A receiver configured to receive state information from each of individual chassis controllers provided in a vehicle and receive route information of the vehicle from an advanced driver assistance system. A control signal generator configured to determine a target vehicle motion for the vehicle to move according to the route information and generate control signals for the individual chassis controllers, to control the vehicle to move according to the target vehicle motion. A motion limiter configured to generate maximum curvature information of a curvature at which the vehicle is able to maneuver based on at least one of the state information or road surface information. A transmitter configured to transmit the maximum curvature information to the advanced driver assistance system and transmit the control signals to the individual chassis controllers.

### CROSS REFERENCE TO RELATED APPLICATION

This application claims priority from Korean Patent Application No. 10-2024-0075282, filed on Jun. 10, 2024, which is hereby incorporated by reference for all purposes as if fully set forth herein.

### BACKGROUND

### Field

Embodiments relate to chassis-integrated control technology for controlling motions of a vehicle.

### Description of Related Art

Recently, in the automotive industry, the development of driver assistance technology and autonomous driving technology has attracted attention due to the development of information and communication technology and the increasing importance of personal leisure.

In this context, autonomous driving refers to a technology that recognizes the surrounding environment, determines the driving situation, and controls a host vehicle without driver intervention, using in-vehicle sensors, such as light detection and ranging (LiDAR) sensors or global positioning system (GPS) receivers, and external information such as map information. Accordingly, these days, the driving stress of drivers may be reduced, and the advantage of more productive or leisure time in the vehicle may be provided.

In addition, a variety of in-vehicle functions using the advanced driver assistance system (ADAS), including lane-keeping assistance, lane-following control, and lane-departure prevention, have been added, and uses thereof are growing.

As the types and functions of the ADAS become increasingly diverse, it is required to recognize and determine various situations and perform various operations to control motions of the vehicle.

From this point of view, the amount of computation of the ADAS for processing an increasingly greater amount of situation judgment and vehicle motions is rapidly increasing. In addition, in a case in which the ADAS performs vehicle motion control after the situation determination, there is also a problem that it is difficult to respond in a timely manner due to consumption of the computing time.

That is, if the ADAS is required to perform all functions, including situation recognition, judgment, and vehicle motion control, to support a continuously increasing variety of functions, there is a risk that problems, such as increased computation, inability to control vehicle motions in case of failure, and limited adaptive control of various in-vehicle motion control systems, may occur.

To overcome these problems, a more appropriate system architecture configuration is required.

### BRIEF SUMMARY

Embodiments are intended to provide chassis-integrated control technology for controlling motions of a vehicle.

In an aspect, embodiments provide a chassis-integrated controller including: a receiver configured to receive state information from each of individual chassis controllers provided in a vehicle and receive route information of the vehicle from an advanced driver assistance system; a control signal generator configured to determine a target vehicle motion for the vehicle to move according to the route information and generate control signals for the individual chassis controllers, to control the vehicle to move according to the target vehicle motion; a motion limiter configured to generate maximum curvature information of a curvature at which the vehicle is able to maneuver based on at least one of the state information or road surface information; and a transmitter configured to transmit the maximum curvature information to the advanced driver assistance system, and transmit the control signals to the individual chassis controllers.

In another aspect, embodiments provide a vehicle control system including: an advanced driver assistance system configured to generate route information including a target route for a vehicle to travel based on maximum curvature information and sensing information generated by sensors provided in the vehicle; a chassis-integrated controller configured to generate the maximum curvature information of a curvature at which the vehicle is able to maneuver based on state information and road surface information received from individual chassis controllers, and generate a control signal for each of the individual chassis controllers so that the vehicle operates in accordance with the route information; and an individual chassis controller configured to control motions of the vehicle by receiving control signals from the chassis-integrated controller.

According to exemplary embodiments, chassis-integrated control technology for controlling motions of a vehicle may be provided.

### DESCRIPTION OF DRAWINGS

The above and other objects, features, and advantages of the present disclosure will be more clearly understood from the following detailed description, taken in conjunction with the accompanying drawings, in which:

FIG. 1 illustrates the configuration of a chassis-integrated controller according to embodiments;

FIG. 2 illustrates route information according to an embodiment;

FIG. 3 illustrates route information according to another embodiment;

FIG. 4 illustrates generation of maximum curvature information based on road surface friction according to an embodiment;

FIG. 5 illustrates generation of maximum curvature information based on road surface friction according to another embodiment;

FIG. 6 illustrates generation of maximum curvature information based on failure information according to another embodiment;

FIG. 7 illustrates generation of maximum curvature information based on road surface friction and failure information according to another embodiment;

FIG. 8 illustrates the configuration of a vehicle control system according to embodiments;

FIG. 9 illustrates the operation of the vehicle control system according to embodiments; and

FIG. 10 illustrates the operation of the vehicle control system in a failure situation according to embodiments.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

There is a growing demand for a variety of autonomous or driver assistance functions in vehicles. These may provide a variety of effects, such as improved driver comfort and accident prevention. Accordingly, various types of driver assistance functions have recently been commercialized by various companies in the automotive industry, such as automobile manufacturers and parts manufacturers. In this specification, a system, a device, or an ECU providing driver assistance functions will be described as an advanced driver assistance system (ADAS).

For example, the ADAS detects and recognizes terrain features based on cameras, radars, light detection and ranging (LiDAR) sensors, ultrasonic sensors, and the like. The ADAS determines the situation of a host vehicle and generates a vehicle route based on the situation using the result of the detection and recognition. The ADAS assists the driver using the generated vehicle route, notifications provided by individual functions, and the like. For example, the ADAS may directly compute operating instructions for individual chassis products to assist the driver and transmit the operating instructions to the individual chassis products.

Traditional driver assistance functions have been able to control vehicle motions with simple chassis maneuvers, such as keeping the vehicle in the lane at low to medium speeds or stopping the vehicle when a pedestrian or an obstacle is detected. Therefore, even if the ADAS generates control signals for one chassis system (e.g., a steering or braking system), the ADAS may provide traditional driver assistance functions.

However, as driver assistance functions for vehicles have been gradually developed, some situations require the ability to avoid obstacles while maintaining an appropriate driving speed, rather than simply stopping if an obstacle is detected. In addition, functions for simultaneously controlling various chassis systems in the vehicle, such as rear wheel steering, lateral braking, and suspension control, are being developed, in addition to steering, in order to handle vehicle motions faster and safer.

In this situation, it is difficult to create an optimal vehicle motion by considering the stability of the vehicle by simply manipulating a single chassis system by the computation of the existing ADAS.

In summary, current architectures in which the ADAS directly computes operating instructions for chassis products and the drivetrain to detect terrain features, generate a route, and produce an optimal vehicle motion may lead to the following issues: (1) the ADAS is bigger and more computationally intensive than before; (2) the need for the ADAS to perform vehicle motion control in similar situations in driver mode rather than ADAS situations; and (3) the inability to control vehicle motions in driver mode in the event of an ADAS failure.

To overcome these issues, the present disclosure proposes an architecture in which an ADAS and a separate chassis-integrated controller are provided in a vehicle, and the chassis-integrated controller controls individual chassis systems (or individual chassis controllers). Also proposed are specific operations between the systems and the controllers to reliably perform system operations in such an architecture.

As a result, it is possible not only to reduce the amount of computation required for the ADAS to control the chassis, but also to provide reliable vehicle motion operations in the event of an ADAS failure.

As used herein, the term “chassis” refers to the remaining parts of a vehicle from which the body is removed. For example, a chassis refers to the essential configurations required drive the vehicle. The engine, power train, steering device, brakes, suspension, and the like are all included in the chassis.

For example, the individual chassis controllers refer to controllers for controlling individual devices, such as drive, steering, braking, and suspension devices, of a vehicle. A chassis-integrated controller refers to a controller for controlling these individual chassis controllers. The individual chassis controllers and the devices provided in each vehicle are described herein by way of example, and may be omitted or further added.

Various embodiments of the present disclosure will be described below, each of which may be practiced individually or in any combination.

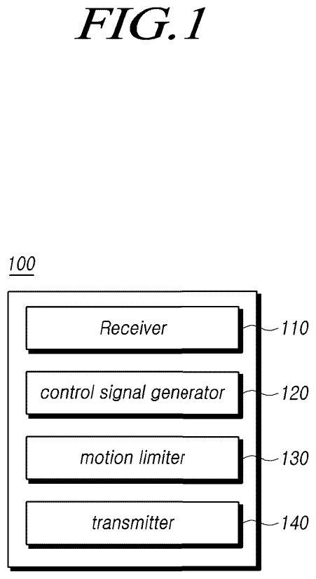

FIG. 1 illustrates the configuration of a chassis-integrated controller according to embodiments.

Referring to FIG. 1, a chassis-integrated controller 100 may include a receiver 110 configured to receive state information from each of individual chassis controllers provided in a vehicle and route information for the vehicle from an advanced driver assistance system (ADAS).

For example, the receiver 110 may receive necessary information from the individual chassis controllers or the ADAS through in-vehicle communications (e.g., CAN). In addition, the receiver 110 may receive information from various in-vehicle devices other than the individual chassis controllers and the ADAS. The information may be received through a wired signal line, such as an in-vehicle public CAN or an in-vehicle private CAN. In another example, the information may be received through wireless communication. There are no limitations in the communication method by which information is received.

For example, the receiver 110 may receive state information from the individual chassis controllers. For example, the individual chassis controllers may refer to controllers, such as an ECU, for controlling various configurations of devices in the vehicle. In an example, the individual chassis controllers may include a braking controller for applying braking force to the vehicle, a front wheel steering controller for applying front wheel steering force to the vehicle, a rear wheel steering controller for applying rear wheel steering force to the vehicle, and a suspension controller for applying damping force to the vehicle. In another example, the individual chassis controllers may further include various controllers for controlling devices configured variously depending on the vehicle, such as an electronic limited-slip differential (e.g., e-LSD).

The state information may be received from the individual chassis controllers and include information on whether each of the individual chassis controllers has failed. Here, the failure of the individual chassis controller may include a failure of a target device controlled by the individual chassis controller, as well as a failure of the individual chassis controller itself. In addition, the state information may include a maximum allowable control value for each of the individual chassis controllers. The maximum allowable control value may indicate a maximum control value that the individual chassis controller may output for a device controlled by the individual chassis controller. For example, the maximum allowable control value may indicate a maximum braking value that the braking controller may apply to the brakes. Similarly, the maximum allowable control value may indicate a maximum steering torque or a maximum steering angle that the front wheel steering controller may apply for front wheel steering. In this manner, the maximum allowable control value is the maximum control value that each of the individual chassis controllers may output for control, and may be associated with the state of the individual chassis controller or an individual chassis device. For example, if a particular chassis device or an individual chassis controller is not in a normal state, a control value that is only half the value of the normal state may be applied. Accordingly, the chassis-integrated controller 100 may check the state of the individual chassis controller by receiving the maximum allowable control value.

In addition, the failure information may indicate whether each of the individual chassis controllers has failed. In another example, the failure information may indicate whether the chassis device controlled by the individual chassis controller has failed. The failure information may be received in various forms. For example, the failure information may be failure flag information received from the individual chassis controller or a period signal that the individual chassis controller periodically transmits if the individual chassis controller is in a normal state.

In an example, if it is determined that the individual chassis controller has failed, the failure flag information may be received by the receiver 110. In another example, the failure flag information may be set to and received as values categorized depending on the failure state of the individual chassis controller (i.e., the ability to perform some of the functions). In another example, the failure flag information may indicate a case in which some of the individual chassis controllers are in a failure state, thereby allowing only a certain level of control. In this case, the failure information may include the maximum allowable control value described above.

In addition, the failure information may be a period signal. For example, the individual chassis controller may transmit a periodic flag or signal to the receiver 110 at a predetermined period. If the periodic flag or signal is not received from the individual chassis controller at the predetermined period, it may be determined that the individual chassis controller has failed. Similar to the failure flag information, in the case of the period signal, various signals may be transmitted to the receiver 110 at the corresponding predetermined period, depending on the type or state of failure.

The receiver 110 may receive route information of the vehicle from the ADAS. For example, the route information may indicate information on a target route for the vehicle to travel.

For example, the route information may be generated by the ADAS based on sensing information and maximum curvature information. The route information may include coordinate information on the target route for the vehicle to travel or polynomial information for calculating the target route. The route information of the vehicle may be set by the ADAS using the sensing information, and the receiver 110 may only receive information on the set target route of the vehicle.

In an example, the route information may include the coordinate information that indicates the target route for the vehicle to travel. That is, the route information may include information on coordinates in two dimensions for the vehicle to travel. In another example, the route information may include polynomial information. For example, a polynomial may represent a graph in two dimensions, and the graph may be the target route for the vehicle. If the route information is configured in the form of a polynomial, the coefficients in the polynomial may be used to direct the target route of the vehicle only using simpler information. The route information in the form of a polynomial may be transmitted and checked by a mutually predetermined protocol between the ADAS and the chassis-integrated controller. In addition, the route information may also be configured to include various other information, such as vehicle's heading angle, vehicle speed, and distance.

In addition, the chassis-integrated controller 100 may include a control signal generator 120 to determine a target vehicle motion for the vehicle to move in accordance with the route information and generate a control signal for each of the individual chassis controllers so that the vehicle is operated according to the target vehicle motion.

For example, if the route information is received, the control signal generator 120 may determine vehicle motions required for the vehicle to move along the route. The vehicle motions may include steering, braking, suspension, and other vehicle motions for determining the movement of the vehicle while enhancing driver comfort and safety.

For example, the control signal generator 120 may determine a target vehicle motion including yaw rate information of the vehicle that allows the vehicle to travel in accordance with the route information. In addition, the control signal generator 120 may generate a control signal including at least one of a braking torque, a front wheel steering angle, a front wheel steering torque, a rear wheel steering angle, a rear wheel steering torque, or a damping ratio required to realize the target vehicle motion.

In determining the target vehicle motion, the control signal generator 120 may consider the state information described above. For example, if the front wheel steering has failed, the control signal generator 120 may determine the target vehicle motion for the vehicle to travel on the target route using the rear wheel steering, brakes, and suspension.

Once the target vehicle motion is determined, the control signal generator 120 may generate control signals to be transmitted to the individual chassis controllers to realize the target vehicle motion. As described above, the control signals may be generated by considering characteristics, performance, state, and the like of the individual chassis controllers. In addition, the control signals may be generated with different values for the individual chassis controllers.

In addition, the chassis-integrated controller 100 may include a motion limiter 130 that generates, based on at least one of the state information or the road surface information, the maximum curvature information of a curvature at which the vehicle is able to maneuver.

For example, the motion limiter 130 may generate the maximum curvature information of a curvature at which the vehicle is able to maneuver by considering the state information of the individual chassis controllers. The maximum curvature information may be generated by applying a predetermined subtraction value for each individual chassis controller based on whether the individual chassis controller has failed, which is checked based on the state information. For example, if all of the chassis devices for controlling the vehicle motions are normal, the maximum curvature at which the vehicle is able to maneuver may be calculated. In such a situation, if one or more of the chassis devices fail or if the operation is partially limited, the maximum curvature may be reduced. Therefore, the maximum curvature information of a curvature at which the vehicle is able to maneuver is calculated by applying the state information obtained from each individual chassis controller. The subtraction value may be set for each individual chassis controller or for each failure type and state of the individual chassis controller. The subtraction value may be set as a percentage, or may be set as a calculation formula. There are no limitations in how the subtraction value may be set.

In another example, the motion limiter 130 may generate the maximum curvature information using road surface information on the road surface on which the vehicle is traveling.

For example, the maximum curvature information may be generated based on the road surface information, including frictional force information on the road surface on which the vehicle is traveling, and may be generated to increase in proportion to the frictional force. The maximum curvature information may be generated with a larger value for a higher frictional force on the road surface. In another example, the maximum curvature information may be generated as a calculation formula that is a single value for a predetermined range of road surface friction. In another example, the maximum curvature information may be generated in a linear or exponential relationship with the road surface friction.

In another example, the motion limiter 130 may generate the maximum curvature information by considering both the road surface information and the state information. For example, the maximum curvature information may be generated using upper limit curvature information set based on the state information as an upper limit so as to be proportional to the frictional force included in the road surface information. That is, the maximum curvature information may be generated according to the frictional force of the road surface using the upper limit curvature information set according to whether the individual chassis controller has failed as an upper cap.

The maximum curvature information may be used by the ADAS to generate route information. For example, the route information may be calculated by applying the maximum curvature information as the maximum turning radius of the vehicle. The ADAS may generate a travel route for the vehicle that does not exceed the maximum curvature information. Consequently, even in a situation where route generation and vehicle motion control are separate, the optimal route may be generated based on the condition of the vehicle. The ADAS may receive only the maximum curvature information and use the received maximum curvature information for the route information, thereby preventing increases in computation time due to unnecessarily increased computation.

In addition, the chassis-integrated controller 100 may include a transmitter 140 to transmit the maximum curvature information to the ADAS and transmit control signals to the individual chassis controllers.

For example, the transmitter 140 may transmit the generated maximum curvature information to the ADAS. The maximum curvature information may be transmitted to the ADAS periodically or aperiodically. In an example, only curvature information changes, the transmitter 140 may aperiodically transmit changed maximum curvature information. In another example, the transmitter 140 may transmit the maximum curvature information to the ADAS according to a predetermined period independent of changes in the maximum curvature information. In another example, the transmitter 140 may transmit generated maximum curvature information, or may transmit a difference value from previously transmitted maximum curvature information.

In addition, the transmitter 140 may transmit control signals for controlling the individual chassis controllers to the individual chassis controllers. The control signals may be generated by the control signal generator 120. The transmitter 140 may also transmit synchronization information on the control signals to cause the individual chassis controllers to control motions of the vehicle in accordance with the control signals at a synchronized time.

Through this operation, the ADAS may provide fast and accurate determination by performing only cognitive determining and vehicle route generating functions. In addition, the chassis-integrated controller may generate control signals to control the vehicle motions in accordance with the route information, thereby enabling fast and adaptive vehicle motion control. In addition, even in a situation in which the ADAS has failed or the ADAS is unnecessary, various chassis devices in the vehicle may be controlled in an integrated manner.

In some embodiments, each of the receiver 110, the control signal generator 120, the motion limiter 130, and the transmitter 140 includes one or more hardware processors.

In the following, respective configurations and a variety of embodiments will be described with reference to the drawings.

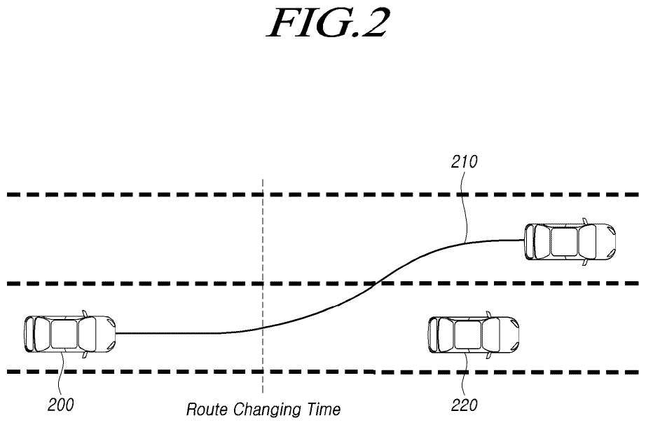

FIG. 2 illustrates route information according to an embodiment.

Referring to FIG. 2, the chassis-integrated controller receives route information of the vehicle from the ADAS and accordingly determines the target vehicle motion. In this regard, the chassis-integrated controller is required to receive the route information.

For example, if a host vehicle 200 is traveling, the ADAS may detect a preceding vehicle 220 using sensors mounted on the host vehicle, such as radar sensors. If it is determined that it is necessary to avoid the front vehicle 220, the ADAS may generate route information 210 that allows the vehicle 200 to evade the front vehicle 220. The route information 210 may be determined based on various algorithms, such as sensors and modes, set in the ADAS.

For example, in generating the route information 210 for the vehicle, the ADAS is required to have information on a maximum turning radius within which the vehicle is able to maneuver. This is because the route information 210 is required to be generated so that the vehicle 200 turns within the maximum turning radius. In addition, a rerouting time point of the vehicle 200 may be determined by considering the maximum turning radius. If the maximum turning radius is smaller (large curvature), the vehicle may turn more sharply. However, it may be difficult for the ADAS to directly calculate such a maximum turning radius.

Accordingly, in the present disclosure, the chassis-integrated controller may transmit the maximum curvature information to the ADAS. The maximum curvature information may include information on the maximum curvature at which the vehicle is able to maneuver.

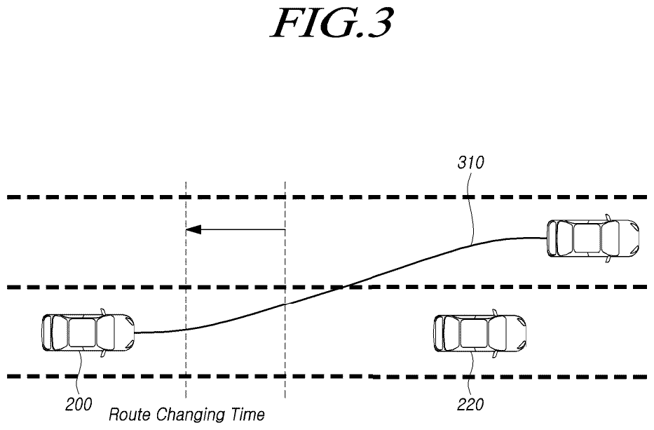

FIG. 3 illustrates route information according to another embodiment.

Referring to FIG. 3, if the chassis-integrated controller changes maximum curvature information, the ADAS sets route information 310 differently. Compared to FIG. 2, it may be seen that a time point at which the route is changed is earlier, and that jerky actions of the vehicle 200 are reduced in view of the route information 310.

That is, the ADAS may check the maximum turning radius of the vehicle using the sensing information and the maximum curvature information received from the chassis-integrated controller and generate route information 310 for the vehicle 200 using the maximum turning radius.

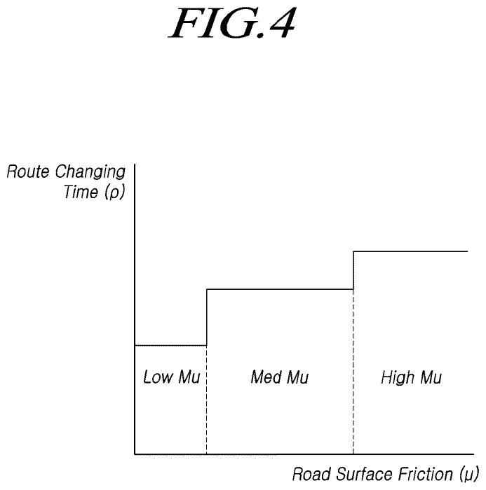

FIG. 4 illustrates generation of maximum curvature information based on road surface friction according to an embodiment.

Referring to FIG. 4, the chassis-integrated controller may generate maximum curvature information based on at least one of state information of the vehicle and road surface information. The road surface information may include frictional force information of the road surface. The frictional force information may be estimated by and received from a frictional force estimator provided in the vehicle. In another example, the frictional force information may be calculated by the chassis-integrated controller using the speed, the yaw rate, or the like of the vehicle.

For high-friction surfaces, the vehicle may be able to support more dynamic actions. In contrast, for slippery surfaces, the vehicle motions may be constrained by considerations of vehicle safety or the like.

In consideration of such features, the chassis-integrated controller may generate the maximum curvature information for the ADAS to use when calculating route information.

For example, the maximum curvature information may be generated to increase in proportion to the frictional force included in the road surface information. That is, as the frictional force increases, the maximum curvature at which the vehicle is able to maneuver may also increase. In another example, the chassis-integrated controller may perform the control to generate corresponding maximum curvature information for each frictional force range.

The chassis-integrated controller may categorize the road surface friction into low, medium, and high frictional force ranges, and generate a maximum curvature for each of the frictional force ranges. The frictional force ranges may be set in advance, and may be two or more frictional force ranges. However, even in this case, the high frictional force range may be set such that a high maximum curvature is mapped thereto.

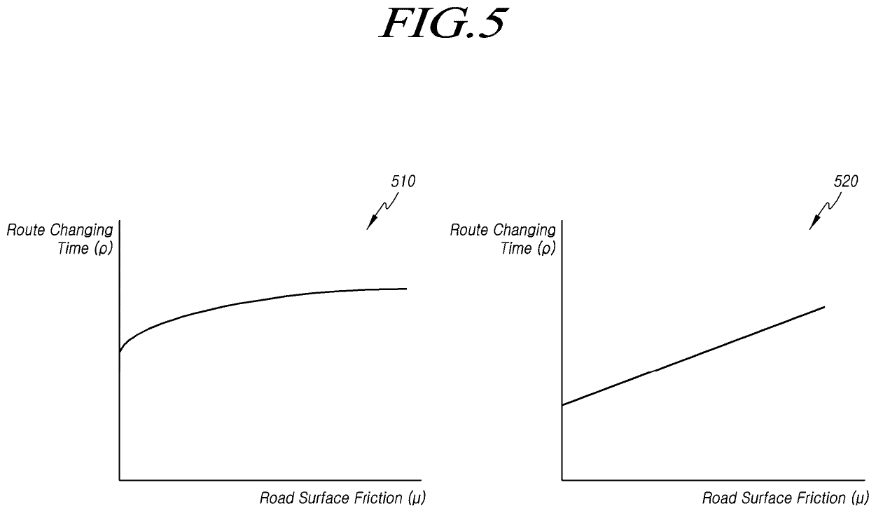

FIG. 5 illustrates generation of maximum curvature information based on road surface friction according to another embodiment.

Referring to FIG. 5, a maximum curvature may be generated as a value linear to road surface friction (520). In another example, the maximum curvature may be generated to converge to a predetermined value as the road surface friction increases (510).

As in the case of 510, a predetermined level of maximum curvature may be set even if the road surface friction is low, and the amount of increase in the maximum curvature may be set to decrease as the road surface friction increases. In addition, or in another example, the maximum curvature may be set such that the increment thereof increases as the road surface friction increases or decreases.

In another example, the road surface friction and the maximum curvature may be generated to match linearly, as in the case of 520.

As shown in FIGS. 4 and 5, the maximum curvature may be set in association with the frictional force of the road surface, but consideration of the states of the individual chassis controllers may also be desired. For example, if all of the chassis devices in the vehicle are in normal states, the maximum curvature information may be generated in association with the frictional force, as shown in FIG. 4 or 5. On the other hand, if a particular chassis device in the vehicle has failed and thus is unavailable, it may be necessary to consider not only the frictional force but also the failure of the corresponding chassis device for the maximum curvature.

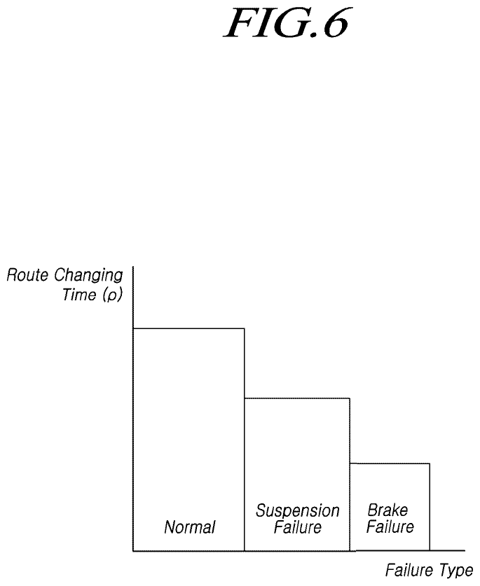

FIG. 6 illustrates generation of maximum curvature information based on failure information according to another embodiment.

Referring to FIG. 6, the chassis-integrated controller receives state information from each of the individual chassis controllers. The state information may include at least one of failure information or a maximum allowable control value of each individual chassis controller.

Conventionally, the turning motion of a vehicle is performed by front wheel steering or rear wheel steering. However, the chassis-integrated controller of the present disclosure may integrally control the chassis devices of the vehicle. Thus, in order to achieve a stable and high turning angle, the chassis-integrated controller may consider not only front and rear steering, but also steering by one-way braking and suspension control of the vehicle.

Accordingly, the maximum curvature at which a vehicle is able to maneuver varies depending on the failure of the individual chassis devices provided in the vehicle.

For example, if all of the individual chassis controllers used by the chassis-integrated controller to derive a target vehicle motion are in a normal state, the maximum curvature may be set to be the highest. In contrast, if the chassis controller controlling the suspension is in a failure state, the maximum curvature will be lower than in the normal state. In addition, if the chassis controller controlling the brakes having more influence on the vehicle motions than the suspension has a failure state, the maximum curvature may be generated to be lower.

In this manner, the chassis-integrated controller may generate maximum curvature information using the state information received from the individual chassis controllers.

As described above, the state information may include not only whether a failure has occurred, but also the maximum allowable control value depending on the situation. For example, if the steering device of the vehicle includes a motor having a double-wound structure, a failure may occur in one winding. In this case, the steering may only generate 50% of normal steering force. Accordingly, it would be desirable for the chassis-integrated controller to check the maximum allowable control value in light of a reduced control value and set the target vehicle motion in light thereof, rather than treating such a case as a failure state.

The chassis-integrated controller may generate the maximum curvature information considering the maximum allowable control value described above. For example, if the braking chassis controller in a failure state may provide 50% output, the maximum curvature information may be generated to be higher than in the full failure state of FIG. 6.

In this manner, the chassis-integrated controller may generate the maximum curvature information by considering the state information received from the individual chassis controllers.

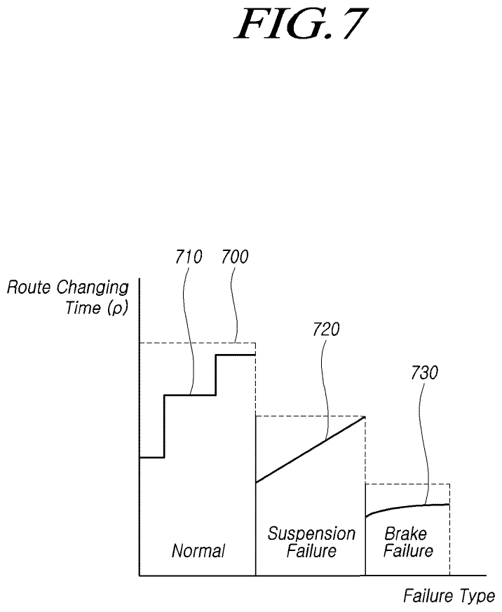

FIG. 7 illustrates generation of maximum curvature information based on road surface friction and failure information according to another embodiment.

Referring to FIG. 7, the chassis-integrated controller may generate maximum curvature information by considering both road surface information and state information.

For example, the maximum curvature information may be generated using upper curvature information 700 set based on the state information as an upper limit so as to be proportional to frictional force included in the road surface information. The chassis-integrated controller may set the upper curvature information 700 based on the state information of each of the individual chassis controllers, as shown in FIG. 6. Once the upper curvature information 700 for each state is generated, the chassis-integrated controller may generate final maximum curvature information for the vehicle by considering the road surface friction in the upper limit curvature information 700. That is, FIGS. 4 to 6 may be integrated to generate the maximum curvature information.

For example, if all of the individual chassis controllers are in a normal state, the upper curvature information 700 may be set to be the highest, and a maximum curvature 710 may be generated based on the frictional force range within the upper curvature. Setting the maximum curvature based on frictional force may be accomplished in a variety of manners, such as 720 and 730, as described in FIGS. 4 and 5.

In another example, if the chassis-integrated controller receives failure information or a maximum allowable control value from an individual chassis controller controlling a suspension device, the chassis-integrated controller may lower the upper curvature 700 in a reflective manner. Thereafter, the chassis-integrated controller may set a maximum curvature 720 by considering frictional force within the upper curvature 700.

In another example, if the chassis-integrated controller receives failure information or a maximum allowable control value from an individual chassis controller controlling the braking system, the chassis-integrated controller may further lower the upper curvature 700 in a reflective manner. Thereafter, the chassis-integrated controller may set a maximum curvature 730 by considering frictional force within the upper curvature 700.

The set forms of maximum curvature based on frictional force of 710 to 730 described above are illustrative, and the same form may be applied to the respective failure states. In another example, the maximum curvature information based on frictional force may be generated in forms other than 710 to 730.

Due to the operation described above, the route may be set faster or more abruptly using the ADAS, and the vehicle motion control may be performed using such routes. In addition, the chassis-integrated controller allows the same vehicle motion control to be performed in both ADAS and driver modes.

In the following, a vehicle control system including a chassis-integrated controller will be described with reference to the drawings. Some descriptions of the operation of the chassis-integrated controller may be omitted to avoid redundant descriptions. The chassis-integrated controller in the vehicle control system may perform all of the operations described above with reference to FIGS. 1 to 7.

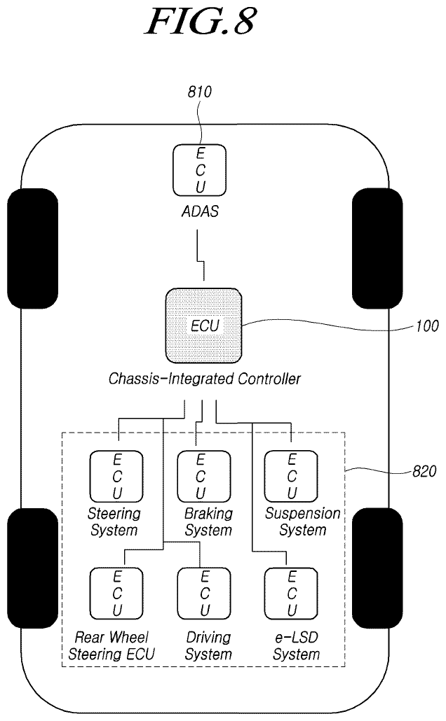

FIG. 8 illustrates the configuration of a vehicle control system according to embodiments.

Referring to FIG. 8, the vehicle control system may include: an ADAS 810 configured to generate route information including a target route for a vehicle to travel based on maximum curvature information and sensing information generated by sensors provided in the vehicle; a chassis-integrated controller 100 configured to generate the maximum curvature information of a curvature at which the vehicle is able to maneuver based on state information and road surface information received from the individual chassis controllers and generate a control signal for each of the individual chassis controllers so that the vehicle operates in accordance with the route information; and an individual chassis controller 820 configured to control motions of the vehicle by receiving control signals from the chassis-integrated controller.

The ADAS 810, the chassis-integrated controller 100, and the individual chassis controllers 820 may send and receive information using an in-vehicle communication protocol.

The chassis-integrated controller 100 and the ADAS 810 may be implemented as independent control devices. The ADAS 810 may receive sensing information from various sensors in the vehicle and generate the target route for the vehicle to travel.

The chassis-integrated controller 100 may transmit the maximum curvature information to assist the ADAS 810 in generating route information, and may determine a target vehicle motion by receiving the route information.

The individual chassis controllers 820 may be configured for different chassis devices, such as steering, braking, suspension, rear wheel steering, driving, and e-LSD devices. Each of the individual chassis controllers 820 receive the control signal from the chassis-integrated controller 100 to control motions of the corresponding individual chassis device (or chassis system).

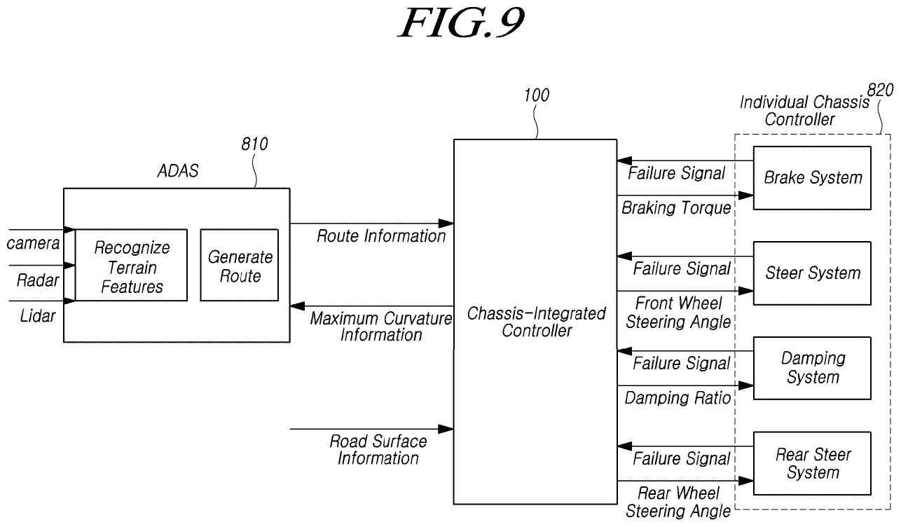

FIG. 9 illustrates the operation of the vehicle control system according to embodiments.

Referring to FIG. 9, the ADAS 810 receives various sensing information using camera sensors, radar sensors, and LiDAR sensors, and the like. Based on the sensing information, the ADAS 810 may determine terrain features around the vehicle and recognize the situation of the vehicle. The ADAS 810 may set a travel route for the vehicle to travel using information such as the results of determining the terrain features around the vehicle, the results of recognizing the situation, and activating ADAS functions.

In this case, the ADAS 810 may receive and use maximum curvature information of a curvature at which the vehicle is able to travel from the chassis-integrated controller 100. That is, the maximum curvature information may be used to reflect the maximum turning radius realizable by the vehicle chassis on the route.

If route information is generated, the ADAS 810 transfers the route information to the chassis-integrated controller 100. The route information may be configured and transferred as various predetermined forms, such as coordinate information and polynomial information.

The chassis-integrated controller 100 may receive the route information and may periodically or aperiodically receive state information from individual chassis controllers 820. The chassis-integrated controller 100 checks failure signals included in the state information to determine whether each of the individual chassis controller 820 has failed, whether a maximum allowable control value is changed, or the like, and determines a target vehicle motion. The chassis-integrated controller 100 generates a control signal for the vehicle to move as the target vehicle motion and transfers the control signal to the individual chassis controllers 820.

In addition, the chassis-integrated controller 100 receives or calculates road surface information and further uses the state information to generate the maximum curvature information of a curvature at which the vehicle is able to maneuver. The maximum curvature information is transferred to the ADAS 810 and used to generate route information.

In response to control signals, the individual chassis controllers 820 control motions of the chassis devices for which the individual chassis controllers 820 are responsible.

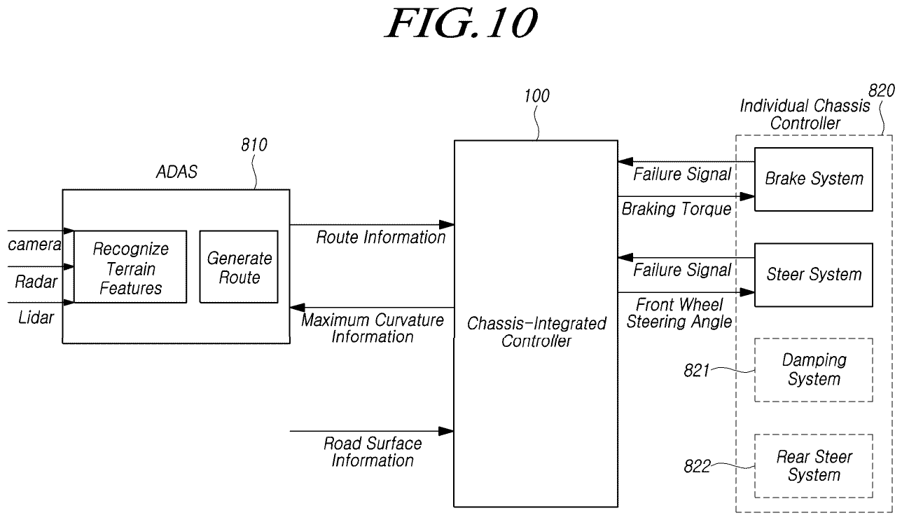

FIG. 10 illustrates the operation of the vehicle control system in a failure situation according to embodiments.

Referring to FIG. 10, some of the individual chassis controllers 820 may fail or some control values thereof may decrease. In this case, the chassis-integrated controller 100 may check state information received from the individual chassis controllers 820 to check whether each of the individual chassis controllers 820 has failed.

As shown in FIG. 10, a damping system 821 and a rear wheel steering system 822 may be in a failure state. The chassis-integrated controller 100 may check whether each of the damping system 821 and the rear wheel steering system 822 has failed by checking the state information. The chassis-integrated controller 100 may newly generate maximum curvature information based on the failure state.

The newly generated maximum curvature information is generated according to the frictional force, with the upper limit thereof reduced depending on the failure state. The maximum curvature information may be set to a lower value compared to a non-failure state.

The chassis-integrated controller 100 transfers the changed maximum curvature information to the ADAS 810. The ADAS 810 generates route information for the vehicle by applying the changed maximum curvature information.

The chassis-integrated controller 100 sets a target vehicle motion using the received route information and transfers control signals for realizing the target vehicle motion only to the braking system and the steering system.

Because the chassis-integrated controller 100 has recognized the failure state of the systems 821 and 822, the chassis-integrated controller 100 may generate the target vehicle motion using only the braking system and the steering system. Because the maximum curvature information is generated by considering the failure state of the systems 821 and 822 and the route information is calculated by reflecting the maximum curvature information, the target vehicle motion may be realized using only the braking system and the steering system.

As described above, in the vehicle control system, the chassis-integrated controller and the ADAS may be separated and perform corresponding functions, thereby enabling more efficient and faster vehicle control. In particular, the ADAS is only required to iteratively generate route information using maximum curvature information without having to consider information on the states of a plurality of chassis devices provided in the vehicle. The chassis-integrated controller is also required to generate control signals of individual chassis controllers according to the routes reflecting these contents, rather than generating routes based on individual chassis devices or sensing information.

Accordingly, in cases in which the ADAS is used or not, vehicle motions may be maintained and controlled in a variety of manners.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A chassis-integrated controller comprising:
a receiver configured to
receive state information from each of individual chassis controllers provided in a vehicle, and
receive route information of the vehicle from an advanced driver assistance system;
a control signal generator configured to
determine a target vehicle motion for the vehicle to move according to the route information, and
generate control signals for the individual chassis controllers, to control the vehicle to move according to the target vehicle motion;
a motion limiter configured to
generate maximum curvature information of a curvature at which the vehicle is able to maneuver based on at least one of the state information or road surface information; and
a transmitter configured to
transmit the maximum curvature e information to the advanced driver assistance system, and
transmit the control signals to the individual chassis controllers.

2. The chassis-integrated controller of claim 1, wherein the individual chassis controllers comprise:
a braking controller configured to apply braking force to the vehicle;
a front wheel steering controller configured to apply front wheel steering force to the vehicle;
a rear wheel steering controller configured to apply rear wheel steering force to the vehicle; and
a suspension controller configured to apply damping force to the vehicle.

3. The chassis-integrated controller of claim 1, wherein the state information comprises at least one of: failure information that indicates whether each of the individual chassis controllers has failed; and a maximum allowable control value of each of the individual chassis controllers.

4. The chassis-integrated controller of claim 3, wherein the failure information is failure flag information, which is received from each of the individual chassis controllers, or a period signal, which each of the individual chassis controllers periodically transmits when the individual chassis controller is in a normal state.

5. The chassis-integrated controller of claim 1, wherein the route information is generated by the advanced driver assistance system based on sensing information and the maximum curvature information, and wherein the route information comprises coordinate information on a target route for the vehicle to travel or polynomial information for calculating the target route.

6. The chassis-integrated controller of claim 5, wherein the route information is calculated by applying the maximum curvature information as a maximum turning radius of the vehicle.

7. The chassis-integrated controller of claim 1, wherein the control signal generator is further configured to
determine the target vehicle motion comprising yaw rate information of the vehicle, to control the vehicle to travel in accordance with the route information, and
generate the control signal comprising at least one of a braking torque, a front wheel steering angle, a front wheel steering torque, a rear wheel steering angle, a rear wheel steering torque, and a damping ratio.

8. The chassis-integrated controller of claim 1, wherein the maximum curvature information is generated based on the road surface information comprising frictional force information on a road surface on which the vehicle is traveling, and wherein in the maximum curvature information, a maximum curvature value is increased in proportion to a frictional force value.

9. The chassis-integrated controller of claim 1, wherein the maximum curvature information is generated by applying a predetermined subtraction value for each of the individual chassis controllers based on whether a respective individual chassis controller has failed, which is checked based on the state information.

10. The chassis-integrated controller of claim 1, wherein the maximum curvature information is generated by using upper limit curvature information, that is set based on the state information as an upper limit, such that a maximum curvature value in the maximum curvature information is proportional to a frictional force value included in the road surface information.

11. A vehicle control system comprising:
an advanced driver assistance system configured to
generate route information comprising a target route for a vehicle to travel based on maximum curvature information and sensing information generated by sensors provided in the vehicle;
a chassis-integrated controller configured to
generate the maximum curvature information of a curvature at which the vehicle is able to maneuver based on state information and road surface information information received from individual chassis controllers, and
generate a control signal for each of the individual chassis controllers so that the vehicle operates in accordance with the route information; and
an individual chassis controller configured to
control motions of the vehicle by receiving control signals from the chassis-integrated controller.

12. The vehicle control system of claim 11, wherein the individual chassis controllers comprise:
a braking controller configured to apply braking force to the vehicle;
a front wheel steering controller configured to apply front wheel steering force to the vehicle;
a rear wheel steering controller configured to apply rear wheel steering force to the vehicle; and
a suspension controller configured to apply damping force to the vehicle.

13. The vehicle control system of claim 11, wherein the state information comprises at least one of: failure information that indicates whether each of the individual chassis controllers has failed; and a maximum allowable control value of each of the individual chassis controllers.

14. The vehicle control system of claim 13, wherein the failure information is failure flag information received from each of the individual chassis controllers or a period signal that each of the individual chassis controllers periodically transmits when the individual chassis controller is in a normal state.

15. The vehicle control system of claim 11, wherein the route information comprises coordinate information on a target route for the vehicle to travel or polynomial information for calculating the target route.

16. The vehicle control system of claim 15, wherein the route information is calculated by applying the maximum curvature information as a maximum turning radius of the vehicle.

17. The vehicle control system of claim 11, wherein the chassis-integrated controller is further configured to:
determine a target vehicle motion comprising yaw rate information of the vehicle, to control the vehicle to travel in accordance with the route information, and
generate the control signal comprising at least one of a braking torque, a front wheel steering angle, a front wheel steering torque, a rear wheel steering angle, a rear wheel steering torque, or a damping ratio.

18. The vehicle control system of claim 11, wherein the chassis-integrated controller is configured to generate the maximum curvature information, and wherein in the maximum curvature information, a maximum curvature value is increased in proportion to a frictional force value included in the road surface information.

19. The vehicle control system of claim 11, wherein the chassis-integrated controller is configured to generate the maximum curvature information by applying a predetermined subtraction value for each of the individual chassis controllers based on whether a respective individual chassis controller has failed, which is checked based on the state information.

20. The vehicle control system of claim 11, wherein the chassis-integrated controller generates the maximum curvature information by using upper limit curvature information, that is set based on the state information as an upper limit, such that a maximum curvature value in the maximum curvature information is proportional to a frictional force value included in the road surface information.
